(19) United States
(12) Patent Application Publication
(10) Pub. No.: US 2015/0032639 A1
(43) Pub. Date: Jan. 29, 2015

(54) SYSTEM AND METHOD FOR PROVIDING NOTIFICATIONS ON PRODUCT RECALLS

(71) Applicant: Verizon Patent and Licensing Inc., Basking Ridge, NJ (US)

(72) Inventor: Tanya D. CHERIFI, Basking Ridge, NJ (US)

(73) Assignee: Verizon Patent and Licensing Inc., Basking Ridge, NJ (US)

(21) Appl. No.: 13/953,484

(22) Filed: Jul. 29, 2013

(51) Int. Cl. G06Q 30/00

(52) U.S. Cl. CPC G06Q 30/014
USPC 705/303

(57) ABSTRACT

An approach for providing notifications on product recalls. The approach includes parsing a transaction history to determine a product acquired by a user. The approach also includes determining recall information associated with the product. The approach further includes presenting a notification to the user regarding the recall information.

### BACKGROUND INFORMATION

Service providers are continually challenged to deliver value and convenience to consumers by, for example, providing compelling network services. One area of development has been enhancing customer service or consumer education. For example, recall information is currently given to government agencies by manufacturers. A user may come across the recall information through news outlets or by checking bulletin boards at stores. Unfortunately, such decentralized methods of distributing recall information means that a user may not receive the recall information. Also, consumers may receive recall information on products they have not purchased. As such, service providers and users face challenges in distributing product recall information to targeted users.

Based on the foregoing, there is a need for providing notifications on product recalls.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing notifications on product recalls, according to an exemplary embodiment;

FIG. 2 is a diagram of a transaction platform capable of parsing transaction history associated with a user, according to an exemplary embodiment;

FIG. 3 is a diagram of a recall platform capable of determining recall information associated with a product, according to an exemplary embodiment;

FIG. 4 is a flowchart of presenting notifications on product recalls, according to an exemplary embodiment;

FIG. 5 is a flowchart of initiating a refund request, according to an exemplary embodiment;

FIG. 6 is a flowchart of determining replacement product recommendations, according to an exemplary embodiment;

FIG. 7 is a flowchart of presenting recall information by brand, according to an exemplary embodiment;

FIG. 8A-8D are diagrams of a user interface utilized in the processes of FIG. 4, according to an exemplary embodiment;

FIG. 9 is a diagram of an extended user interface utilized in the processes of FIG. 4, according to an exemplary embodiment;

FIG. 10 is a diagram of a computer system that can be used to implement various exemplary embodiments; and

FIG. 11 is a diagram of a chip set that can be used to implement various exemplary embodiments.

### DESCRIPTION OF THE PREFERRED EMBODIMENT

An apparatus, method, and software for adapting a metadata framework in accordance with metadata manipulations, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the preferred embodiments of the invention.

Although the various exemplary embodiments are described with respect to processing cloud computing and services, it is contemplated that these embodiments have applicability to other computing technologies and architectures.

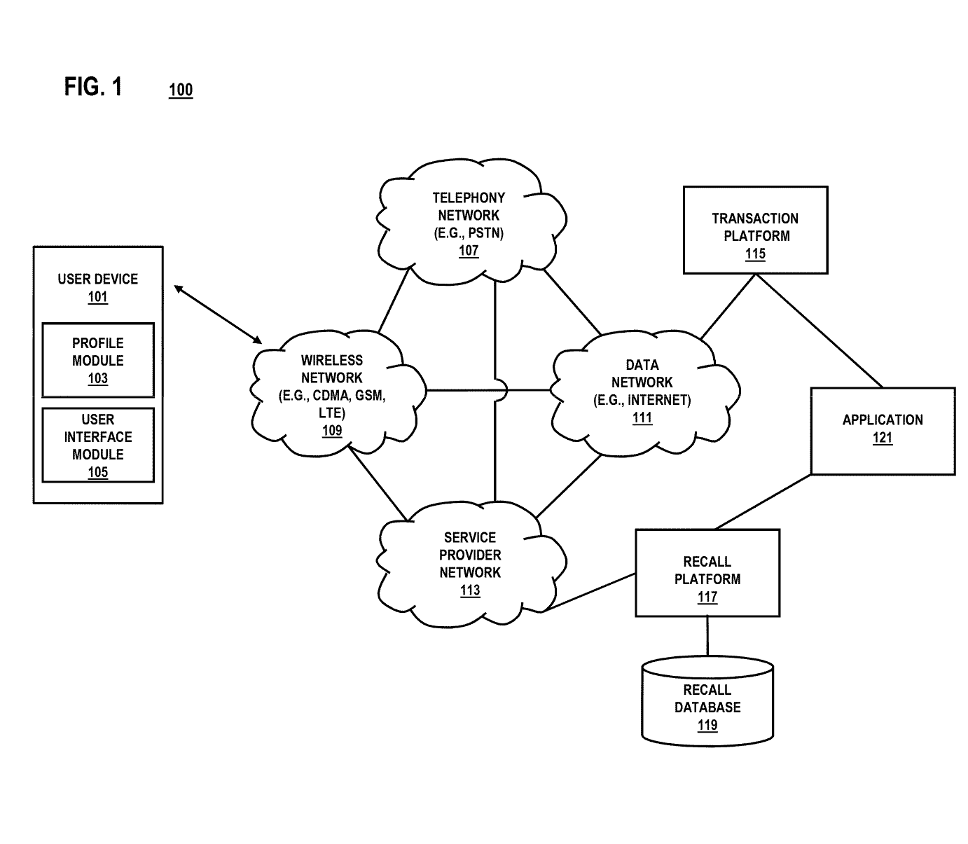

FIG. 1 is a diagram of a system 100 for providing notifications on product recalls, according to one embodiment. For the purpose of illustration, system 100 for providing notifications on product recalls involves displaying notifications at, for example, user device 101. In one embodiment, the user device may include a profile module 103 and/or a user interface module 105. According to certain embodiments, users at the user device 101 may receive notifications over one or more networks, such as telephony network 107, wireless network 109, data network 111, and/or service provider network 113. Additionally, the system 100 may employ transaction platform 115, recall platform 117, and recall database 119 to determine recall information and proper notifications to send to a particular user device 101. The notifications and user device 101 may be connected via application 121, where application 121 may act as an intermediary between the user device 101 and platforms determining appropriate product recall notifications. While specific reference will be made hereto, it is contemplated that system 100 may embody many forms and include multiple and/or alternative components and facilities.

It is observed that recall information often has difficulty reaching consumers. Traditionally, recall information is distributed by manufacturers to government agencies. The agencies may then publicize the information to vendors who may display the information to customers via bulletin boards. Severe recall information is sometimes publicized by media sources, but such coverage is not consistent. Also, the bulletin board method of conveying recall information means that consumers may receive recall information that is not tailored to their purchase histories. As a consequence, a void exists for reliably delivering recall information to consumer who actually acquired (e.g., purchased, received as a gift, etc.) recalled products.

Therefore, the approach of system 100, according to certain exemplary embodiments, stems from the recognition that consumers can benefit from receiving notifications on product recall information pertaining to products they have acquired. Consumers may acquire products through purchase, store rewards and promotions, receiving gifts through electronic transactions, electronically logging received gifts, etc. Receiving gifts through electronic transactions may include direct electronic transfers, for example, transfers of favors or gifts via social networking sites. Electronically logging received gifts may include a user manually logging a product into his device, similar to as if he had purchased the product himself. Electronically logging received gifts may also be automatic, for example, where system 100 may track products purchased for a user through bridal or baby shower registries. In one such embodiment, consumers may provide information on products they have acquired by offering a method to access their transaction history. Transaction histories may include records of a consumer's exchanges associated with stores, payment means, devices, etc. For example, a transaction history associated with a store may include a record of a customer's purchases and returns through the store. A transaction history associated with payment means may include a record of a user's usage of a particular credit card. Device transaction histories may include lists of purchases and returns executed using the device. For instance, if a user uses her mobile phone to make purchases, a device transaction history may detail all of her purchases made using that mobile phone.

In taking into account consumer transaction histories, the system 100 may ensure that only relevant notifications reach consumers. Consumers do not have to receive notifications on recall information on products they did not buy and/or acquire. For example, the system 100 may monitor transactions conducted on a user device 101. For example, a user device 101 may have the capability to directly purchase products. For example, a user device 101 may detect products using Near-Field Communications (NFC) and initiate a purchase transaction of the products. The system 100 may monitor transactions such as this type where the user device 101 directly performs the transactions. Another such instance may include a user device 101 being used to purchase goods online, where the system 100 may monitor the transactions directly.

In another embodiment, the system 100 may determine a transaction history from an electronic payment provider, an image recognition of a receipt for the product, or a combination thereof. Electronic payment providers may include credit or debit accounts, in addition to customer accounts with particular stores. For example, the system 100 may determine a credit card account or customer care card account, where a user's transactions associated with the accounts are accessible if the account is accessible. With image recognition, the system 100 may decipher products or a transaction history based on a captured image of a receipt showing purchase or the transaction history. In another embodiment, the system 100 may include, in the notification, the user's date of acquisition of the product and/or a date of the recall information. In doing so, the user may have a reference point as to when she acquired the product and then possibly, where she might have stored it. The date of the recall information may indicate to the user how recent or up-to-date the recall information may be or if there are any updates. In a further embodiment, notifications may include other product-related information, for example, information identifying the product. For example, notifications may include information on a brand name, number of ounces, expiration date range, ingredients, etc. Such information may be useful where a user may have back-ups of one product and must determine which of the purchased, nearly identical products, might be part of a recalled batch. In yet another further embodiment, notifications may include product recommendations, recommending comparable products with which the user may replace his recalled product. In another embodiment, notifications may include locations where a user may return his product.

System 100 may also permit automatic refunds of the product in conjunction with the recall information, notification, and/or transaction history. For example, the system 100 may be associated with credit card accounts or customer care card accounts to determine a transaction history. Based on the transaction history, the system 100 may determine where a recalled product was purchased and initiate a refund request for the cost of the recalled product, from the vendor that sold the recalled product.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In one embodiment, manufacturers or brands residing within the service provider network 113 may wish to market their commitment to customer care by presenting an association with recall lists. For instance, the brands may aim to produce lists of recall information for products produced by the manufacturers or brands. Then, brands may output safety information, for example, through application 121 to show their responsibility towards civic duty.

In one embodiment, the profile module 103 may determine or track user characteristics and preferences. For example, the profile module 103 may infer user characteristics and preferences in view of user buying habits. In one embodiment, the profile module 103 may contain user information that informs recommendations of products comparable to a recalled product. In another embodiment, the profile module 103 includes information on user location or store preferences to facilitate the user in returning a recalled product. In another embodiment, the profile module 103 may include information on user health, including allergies associated with a user. Then as the system 100 determines product information, the system 100 may also determine product ingredients and warn users where determined ingredients overlap with a user's food allergies.

In another embodiment, the profile module 103 includes user identification information. For example, the profile module 103 may determine an association between a user device 101 and accounts associated with a user, for example, bank accounts or customer accounts. Then, the profile module 103 may facilitate automatic refunds where a user has acquired a recalled product. In another embodiment, the user identification information may include social networking accounts. For example, the profile module 103 may help a user share recall information on social networks associated with the user.

In one embodiment, the user interface module 105 may render all the displays for transaction histories and notifications. The user interface module 105 may interact with the profile module 103, transaction platform 115, recall platform 117, and application 121 to determine user preference settings regarding notification displays, as well as to determine the content and information to display. In one embodiment, the user interface module 105 may offer multiple options for notifications, both for end users and service providers in how recall information should appear on a user device 101.

In one embodiment, the transaction platform 115 may determine and parse transaction history. For example, the transaction platform 115 may determine a user and/or a user device 101 associated with a user and determine transactions associated with the user. For example, a transaction may include product acquisitions or purchasing history. The transaction platform 115 may further determine individual products and product characteristics for products involved in the transactions.

In on embodiment, the recall platform 117 may determine recall information and compare products determined from the transaction history with products associated with recall information. For example, the recall platform 117 may be in contact with a recall database 119 that stores and receives all recall information. For instance, recall database 119 may include any central database, for example, recall information databases maintained by government agencies. In one embodiment, the recall platform 117 identifies products acquired by users that have associated recall information and prompt notifications to be sent to a user device 101.

In one embodiment, may application 121 serve as the means by which the user device 101 interacts with the transaction platform 115 and recall platform 117. For example, application 121 may activate upon detection that a user is acquiring or has acquired products. For example, the application 121 may constantly monitor transactions conducted by the user on user device 101. In another embodiment, the application 121 may cause the user device 101 to receive or render notifications regarding recall information.

By way of example, user device 101 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the user device 101 can support any type of interface to the user (such as “wearable” circuitry, etc.). In one embodiment, the application 121 may be any type of application that is executable at the user device 101.

The service provider network 113 can interact with one or more networks, such as a telephony network 107, a wireless network 109, and/or a data network 111. The service provider network 113 can include at least one application 121 that provide services to the service provider network 113. Additional services associated with, for example, the telephony network 107, the wireless network 109, or the data network 111, may also interact with the user device 101, transaction platform 115, recall platform 117, recall database 119, and application 121. By way of example, a service associated with the data network 111 can store information to files associated with an application 121 of the service provider network 113. For example, electronic payment providers may collect and store transaction information associated with a user at a user device 101. Then, application 121 may provide an interface for the user device 101 to receive the transaction history from data network 111.

For illustrative purposes, the networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. Wireless network 109 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. For instance, the service provider network 113 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of system 100. In this manner, networks 107-113 may embody or include portions of a signaling system 7 (SS7) network, or other suitable infrastructure to support control and signaling functions.

According to exemplary embodiments, end user devices may be utilized to communicate over system 100 and may include any customer premise equipment (CPE) capable of sending and/or receiving information over one or more of networks 107-113. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc.

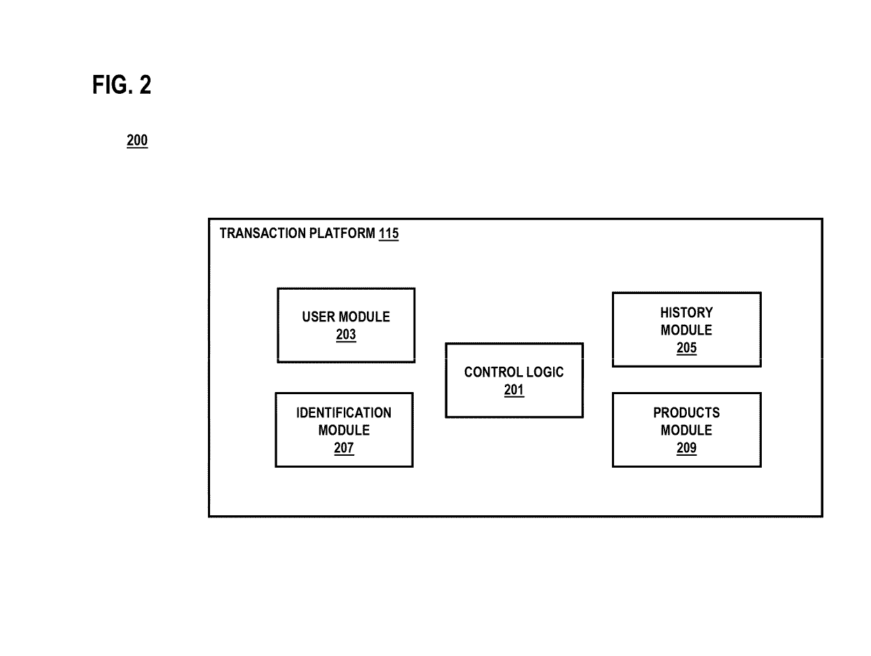

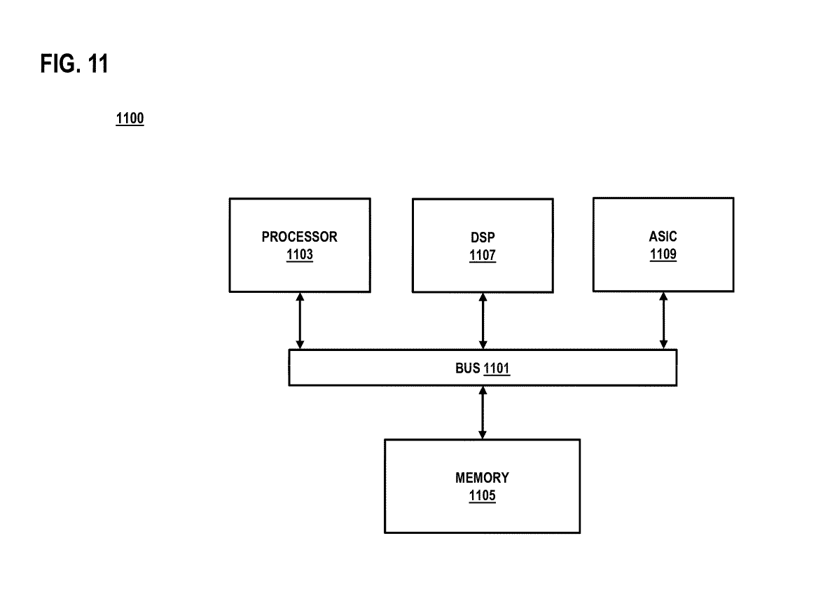

FIG. 2 is a diagram of a transaction platform capable of parsing a transaction history associated with a user, according to one embodiment. Transaction platform 115 may comprise computing hardware (such as described with respect to FIG. 11), as well as include one or more components configured to execute the processes described herein for providing the processing services of system 100. In one implementation, the transaction platform 115 contains a control logic 201, a user module 203, a history module 205, an identification module 207, and a products module 209. The control logic 201 performs control logic functions and facilitates coordination among the other components of transaction platform 115.

In one embodiment, the control logic 201 and user module 203 may identify user profiles or accounts. For example, the control logic 201 and user module 203 may determine electronic payment providers or image recognition input associated with a user. For instance, a user may be associated with multiple electronic payment providers, including credit card providers, customer care card providers, online payment means, money wiring services, etc. The control logic 201 and user module 203 may determine a payment means associated with a user that a user may use to execute transactions.

Based on finding user profiles or accounts, the control logic 201 and history module 205 may determine a transaction history to determine products acquired by users. For example, the control logic 201 and history module 205 may monitor transactions conducted by a user on at least one device. For example, a device may employ Near-Field Communications (NFC) means to detect or identify products. A user may activate the NFC functionality for products she acquires (or as she is acquiring products), where the control logic 201 monitors the acquisitions and compiles the monitored input into a transaction history. For another example, the control logic 201 and history module 205 may determine the transaction history from an electronic payment provider, an image recognition of a receipt for the product, or a combination thereof. For example, the control logic 201 and history module 205 may identify an electronic payment provider for the user identified by the control logic 201 and user module 203. Then, the control logic 201 and history module 205 may query the electronic payment provider for a transaction history associated with the user. Where the transaction history determination involves image recognition of a receipt, the control logic 201 and history module 205 may receive a captured image of a receipt, for example, by interacting with the user interface module 105 of a device. Then, the control logic 201 and history module 205 may employ image recognition to determine individual products listed in the receipt. The control logic 201 and history module 205 may take the products to be part of the transaction history associated with a particular user determined by the control logic 201 and user module 203.

In one embodiment, the control logic 201 and identification module 207 identifies individual products from the transaction history. For example, the control logic 201 and history module 205 may determine a method of acquiring transactions associated with a user, while the control logic 201 and identification module 207 determine individual products that are part of the transactions. In one embodiment, the control logic 201 and identification module 207 may determine various product identification standards or one or more identifiers associated with products. For example, product identification codes or identifiers associated with products may vary by product lines, vendors, and/or manufacturers. The control logic 201 and identification module 207 may determine products by their identifiers.

In one embodiment, the control logic 201 and products module 209 may determine various characteristics or parameters associated with products. For example, the control logic 201 and products module 209 may determine for a product such as a baby crib, characteristics including the brand name of the crib, along with the make and model of the crib. Where a product is, for instance, a condiment in a store, the control logic 201 and products module 209 may determine characteristics including the product's brand name, volume, expiration date range, ingredients, price, etc. The control logic 201 and products module 209 may extend the characteristics inquiry into finding comparable products. For example, the control logic 201 and products module 209 may poll various resources or databases to determine product equivalents. In one scenario, the control logic 201 and products module 209 may work with the profile module 103 to inform a determination of product equivalents by taking into account particular user preferences. In one embodiment, the control logic 201 and products module 209 may further work with the history module 205 to determine characteristics including a user's interaction with a product. For example, the control logic 201, history module 205, and products module 209 may work together to determine a purchase history, including date of acquisition of the product associated with a user. In another example, the control logic 201, history module 205, and products module 209 may determine product vendors, meaning where a product is sold. Then, the control logic 201 and products module 209 may work with devices to determine locations where a user may return or exchange a product. In one embodiment, the control logic 201 and products module 209 may determine the locations while considering the location of a particular device. For example, a certain condiment might be sold nationally and online, but the control logic 201, products module 209, and user device 101 may determine a list of locations local to a user so that the user may conveniently return the condiment.

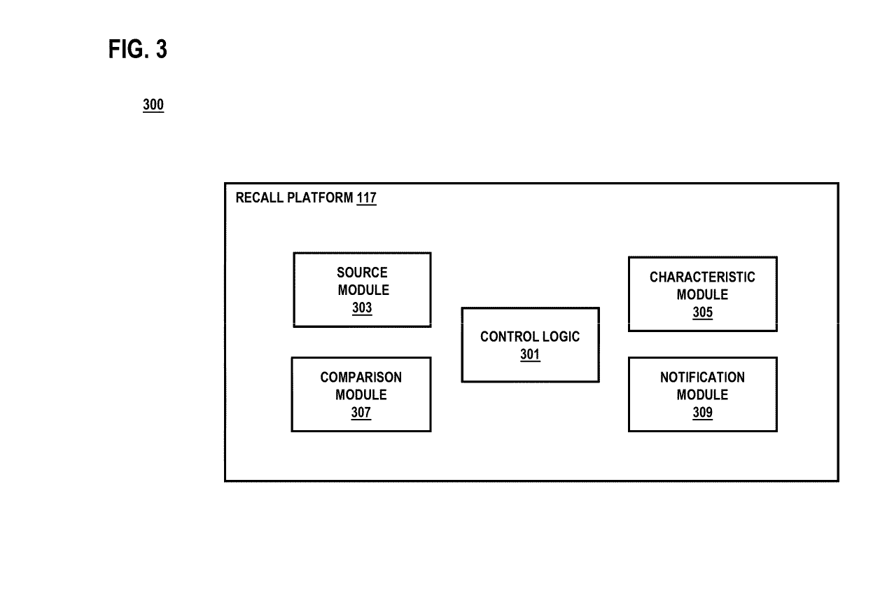

FIG. 3 is a diagram of a recall platform capable of determining recall information associated with a product, according to one embodiment. Recall platform 117 may comprise computing hardware (such as described with respect to FIG. 11), as well as include one or more components configured to execute the processes described herein for providing the processing services of system 100. In one implementation, the recall platform 117 contains a control logic 301, source module 303, characteristic module 305, comparison module 307, and notification module 309. The control logic 301 performs control logic functions and facilitates coordination among the other components of recall platform 117.

In one embodiment, the control logic 301 and source module 303 may determine one or more sources of recall information. For example, the control logic 301 and source module 303 may connect to one or more central databases, for instance, recall databases associated with the government regulatory organizations. Databases may also include databases associated with vendors or brands. Recall database 119 may stand for one database or a collective group of databases providing recall information.

In one embodiment, the control logic 301 and characteristic module 305 may determine identifiers or characteristics associated with products with associated recall information. The control logic 301 and characteristic module 305 may further determine the type of recall information or potential type of injury associated with the recalled product. For example, where a product is recalled for potential infection with salmonella, the control logic 301 and characteristic module 305 may determine that the association with salmonella might be a characteristic associated with the product or certain ingredients in the product. The control logic 301 and characteristic module 305 may also determine various means of identifying the recalled product.

In one embodiment, the control logic 301 and comparison module 307 may compare products in the transaction history of a user against products with recall information as determined by the control logic 301 and characteristic module 305. For example, the control logic 301 and comparison module 307 may receive, from the transaction platform 115, information indicating a user having a transaction with product “A.” Then, the control logic 301 and comparison module 307 may determine that product A has recall information associated with it, as given by product recall lists found by the control logic 301 and source module 303. Where a product from a particular user's transaction is found on a product recall list, the recall platform may act to create a notification.

In one embodiment, the control logic 301 and notification module 309 may simply inform users when products associated with the user's transactions are recalled. For example, the control logic 301 and notification module 309 may present a pop-up where the user is given information on the product, the date of the recall information, and/or the date the user acquired the product. In another embodiment, the control logic 301 and notification module 309 may receive from the transaction platform 115 or determine with the characteristic module 305, recommendations of similar products. In doing so, the control logic 301 and notification module 309 may present the user with replacements or alternatives comparable to the recalled product. In one embodiment, the control logic 301 and notification module 309 may also present one or more vendor locations to the user for a user to more easily return or exchange the product.

In one embodiment, the control logic 301 and notification module 309 may further interact with the recall database 119 where the control logic 301 and notification module 309 may provide a service to brands publicizing recall or safety information associated with the brands' products. For example, brands may subscribe to this notification method of informing customers of product information to show that they are customer-conscious. For instance, the control logic 301 and notification module 309 may determine brands associated with products or categorize products based on brand. Then, the control logic 301 and notification module 309 may present recall information of products associated with the brand, including products with which a user might not have a direct transaction. In doing so, the control logic 301 and notification module 309 may inform customers of product safety in association with brands.

In yet another embodiment, the control logic 301 and notification module 309 may offer social networking options for users to share their recall information. For instance, users may want to inform or warn their friends of product recalls since people often recommend products to friends. The control logic 301 and notification module 309 may facilitate users in sharing recall information with their social network.

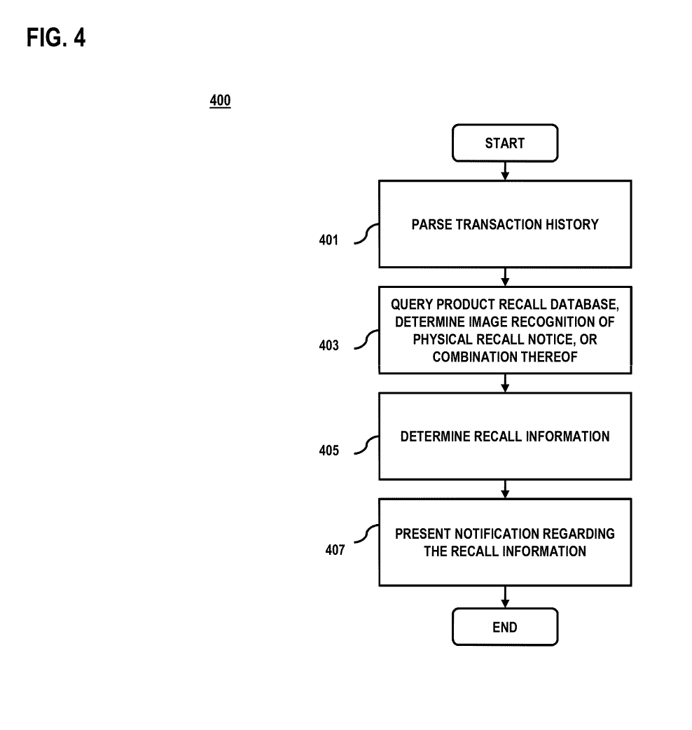

FIG. 4 is a flowchart of presenting notifications on product recalls, according to one embodiment. In step 401, the control logic 201 parse a transaction history to determine a product acquired by a user. For example, the control logic 201 may monitor one or more transactions conducted by the user on at least one device to generate the transaction history. For example, the control logic 201 may determine that a device is directly involved with transactions between a user and products. For example, the control logic 201 may track online purchases associated with a device. In another example, the control logic 201 may determine device transactions using near-field communication (NFC) capability. One such scenario may include a user placing her device close to a product where the device and control logic 201 may then note that the product is part of the user's transaction history. In another example, the control logic 201 may determine the transaction history from an electronic payment provider, an image recognition of a receipt for the product, or a combination thereof. For example, the control logic 201 may contact a service provider associated with a credit card or merchant “customer care” card for transaction history information. In another instance, the user may also take a snapshot of his receipt, where the control logic 201 may then determine products or a transaction history using image recognition on the snapshot of the receipt.

For steps 403 and 405, the control logic 201 may determine recall information associated with the product. In one embodiment, the control logic 201 may determine the recall information from a querying of a product recall database, an image recognition of a physical product recall notice, or a combination thereof. For example, the control logic 201 may find multiple sources of product recall information, including various databases. The control logic 201 may also find product recall information where a user encounters a product recall notice and captures an image of the notice. Then, the control logic 201 may compare the user's transaction history against recall information from the captured image of the recall notice to determine if products in the recall notice appear in a user's transaction history. Then, the control logic 201 may present a notification to the user regarding the recall information for step 407. In one embodiment, the notification to the user includes a date of an acquisition of the product, a date of the recall information, or a combination thereof. In one embodiment, the notification may further include the control logic 201 identifying one or more vendor locations associated with the product and presenting the one or more vendor locations to the user. Offering a user a list of vendor locations may facilitate the user returning a recalled product to a vendor. The control logic 301 may execute some or all of the steps in alternative embodiments.

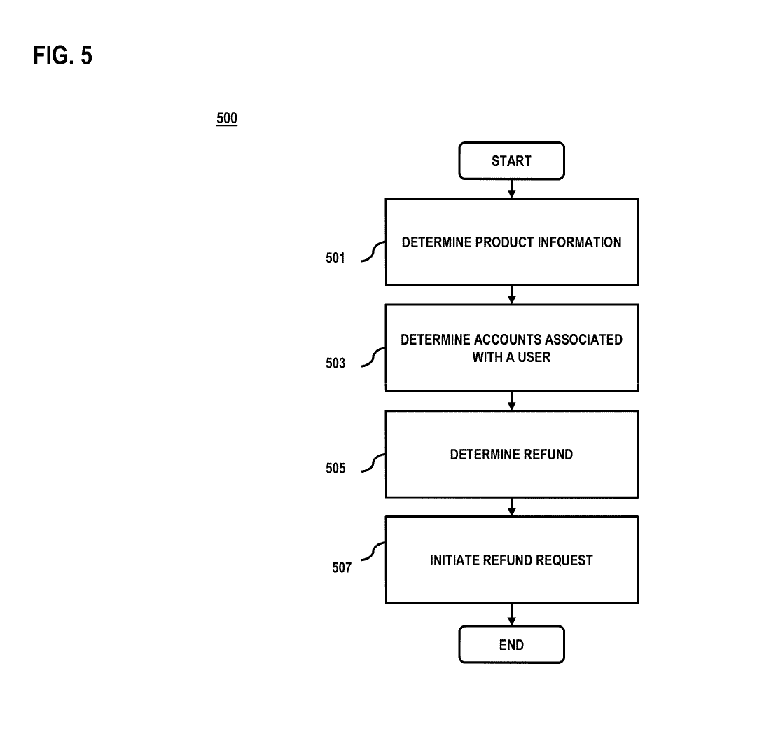

FIG. 5 is a flowchart of initiating a refund request, according to one embodiment. For example, the control logic 301 may initiate a refund request for the product based on the recall information, the notification, the transaction history, or a combination thereof. For instance with step 501, the control logic 301 may first determine product information, including price associated with the product. The price may include various prices associated with the product for different vendors or a price paid by a user in acquiring the product. In step 503, the control logic 301 may determine accounts associated with a user including, price paid by the user or where the monetary amount was transferred from, in order to pay for the product. Then, the control logic 301 may determine a refund amount for step 505. Following these steps, the control logic 301 may initiate a refund request for the product based on the gathered information (step 507). For example, the control logic 301 may initiate a request to either to provide a user with an automatic refund or offer store credit.

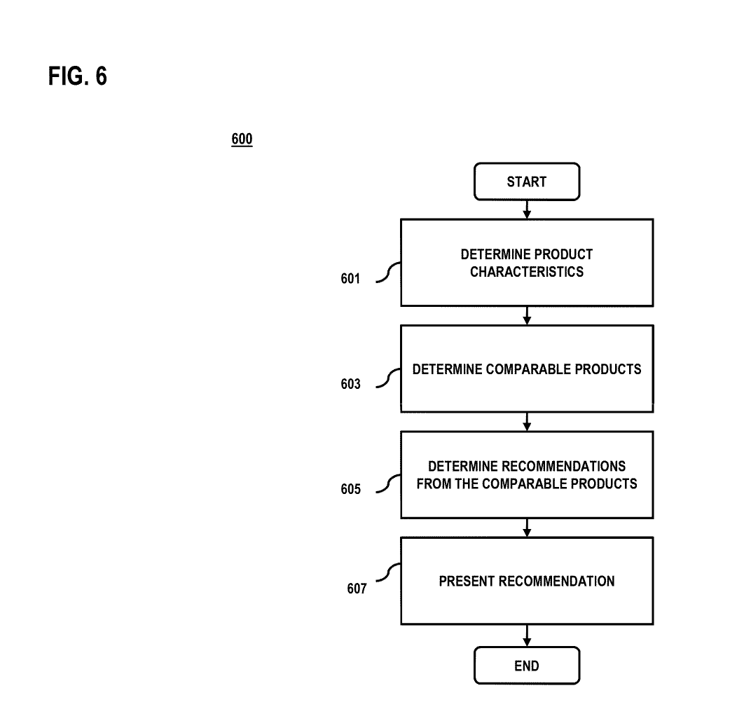

FIG. 6 is a flowchart of determining replacement product recommendations, according to one embodiment. For example, the control logic 301 may determine another product at least substantially comparable to the product and present the another product as a recommendation. For example, the control logic 301 may extract from the recall database 119, metadata associated with products or directly receive from the recall database 119, information on “equivalent” products. In doing so, the control logic 301 may execute steps 601 and 603 in determining product characteristics and finding comparable products based on the product characteristics. From the full set of comparable products, the control logic 301 may allot a subset of the products as recommendations (step 605). For example, the control logic 301 may determine the recommendations based on user profile information on user preferences regarding brands, cost, or available discounts. The control logic 301 may also determine the recommendations from product reviews or ratings. Lastly, the control logic 301 may present the recommendation (step 607). For example, users may have the option to adjust settings on whether to receive recommendations, how many recommendations to receive, or how to prioritize presentation of recommendations. The control logic 301 may present the recommendations according to these settings.

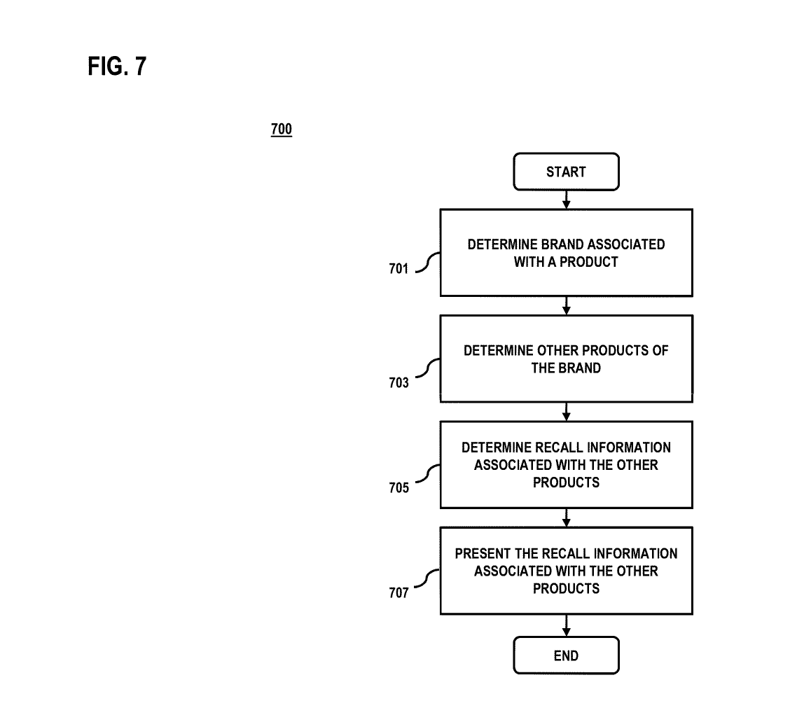

FIG. 7 is a flowchart of presenting recall information by brand, according to one embodiment. In one embodiment, the control logic 301 may determine a brand associated with the product and present other recall information associated with one or more other products of the brand. For example, the control logic 301 may first determine a brand (step 701). For instance, the control logic 301 may determine the brand based on received information regarding a product or acquired product. Alternately, the control logic 301 may determine the brand based on an identification of brands acting as subscribers to a service geared towards offering product recall information. Then, the control logic 301 may determine other products associated with the brand, especially where the products are associated with recall information (steps 703 and 705). After gathering this information, the control logic 301 may present the recall information as categorized by brand (step 707).

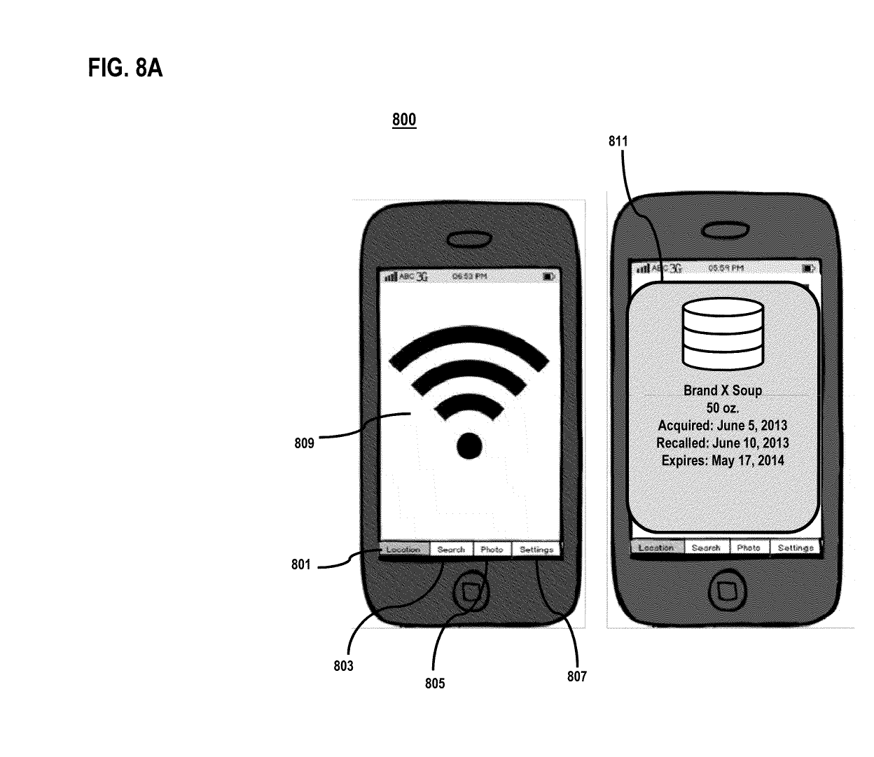

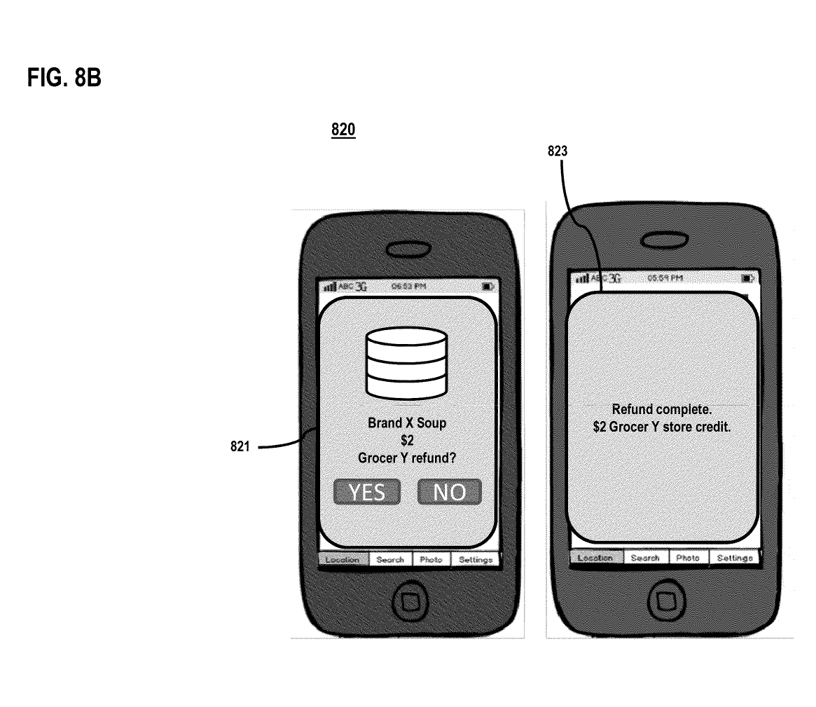

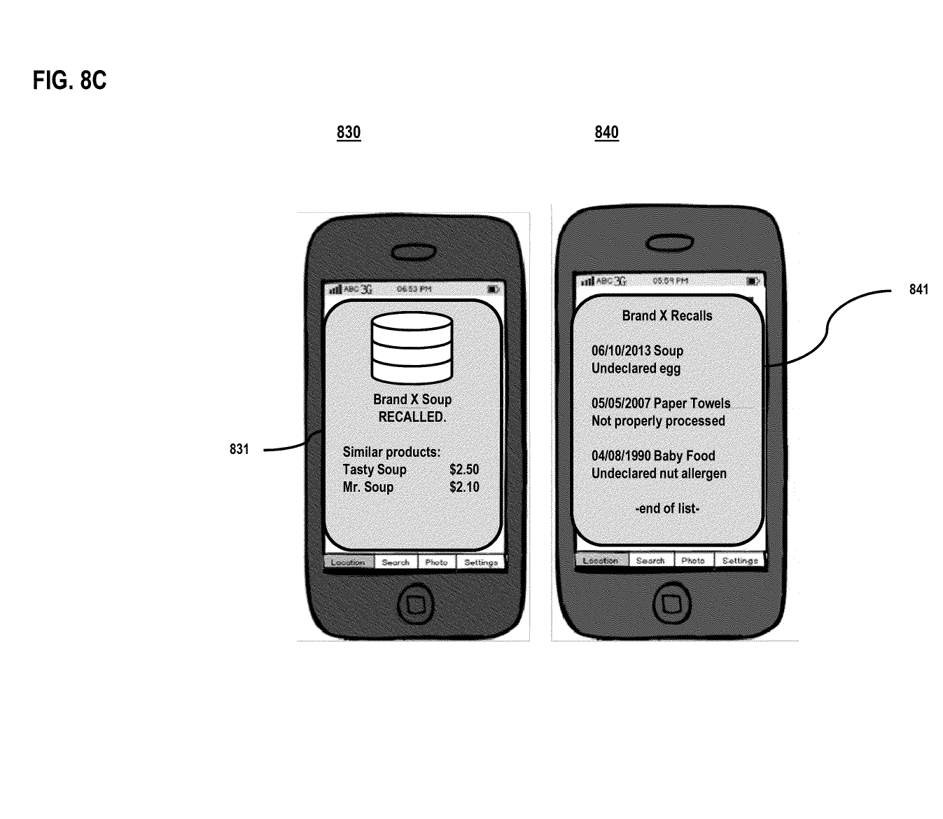

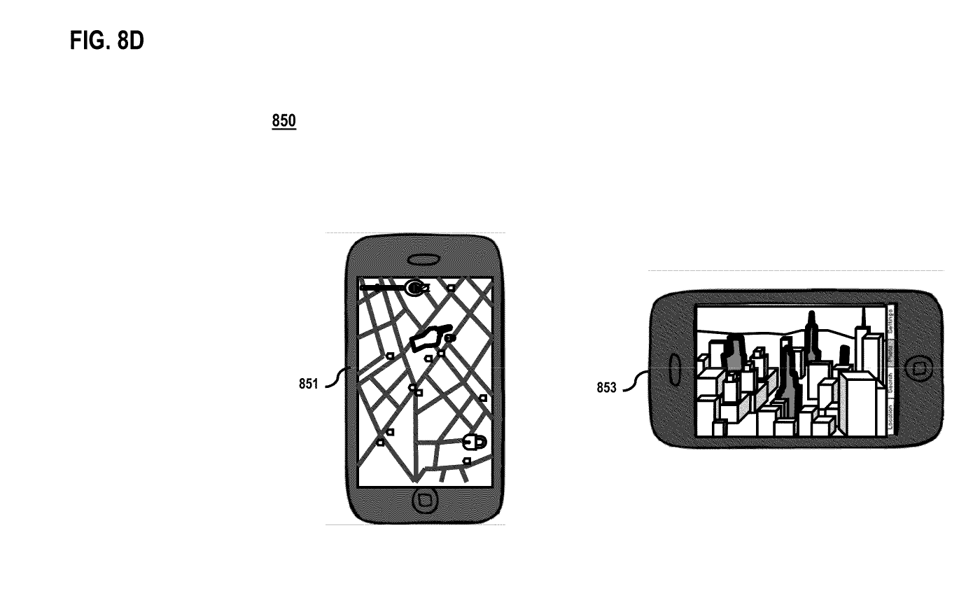

FIG. 8A is a diagram of a user interface utilized in the processes of FIG. 4, according to one embodiment. In one embodiment, user interface 800 may include a location button 801 for to prompt sensor discovery of a user or user device's location. In one embodiment, the location button 801 may find location using global positioning technology (GPS) functions. In one embodiment, the user interface 800 may also include a search button that prompts various means of determining, for example, a transaction history. For example, input from interaction with the location button 801 and search button 803 may lead to screens for a user may detect transactions with products from NFC. In a further embodiment, user interface 800 may include photo button 805 for a user to obtain a screen capture of a receipt or, for example, a credit card associated with an electronic payment provider for the system 100 to determine a transaction history. Settings button 807 may include, for instance, settings for social accounts (for example social networking options), notification settings, or a combination thereof. For example, notification settings may include settings regarding how notifications are appear, what information is included in notifications, or how information is categorized in notifications, or a combination thereof. In one embodiment, the user interface 800 may further include a showing of the device joining a local WiFi network for which the system 100 may access a transaction history by electronic means. For example, the user interface 800 may display symbol 809 when detecting possible communication with a set-top box.

In one embodiment, the user interface 800 may further include a notification 811. As previously discussed, notification 811 may include information regarding the product, including product identification means, for example, weight, brand, or a picture. The notification 811 may also include the date on which a user acquired a product, the date the product was recalled, and expiration date of the product.

FIG. 8B is a diagram of a user interface utilized in the processes of FIG. 4, according to one embodiment. In one embodiment, the user interface 820 may include a refund request 821 that includes the price of the recalled item. In one embodiment, the system 100 may determine the refund request 821 based on a transaction history so the refund is for the price actually paid by a user in buying a recalled product. In another embodiment, the system 100 may base the price of the recalled item on a general market price. The request 821 may include “yes” or “no” prompts for the users to initiate an automatic refund. In one embodiment, user interface 820 may also include confirmation 823 to indicate refund completion and the amount refunded. In one embodiment, confirmation 823 may include an account to which the refund is credited. For instance, confirmation 823 may indicate that the refund is for a bank account or user account in association with a vendor.

FIG. 8C is a diagram of a user interface utilized in the processes of FIG. 4, according to one embodiment. In one embodiment, the user interface 830 may include a list 831 of recommendations. For instance, list 831 may include recommendations regarding products similar or comparable to the recalled product. The recommendations may include further information on the comparable products include price, product reviews, pictures, unit price, ingredients, etc. In one embodiment, the list 831 may permit user interaction with the recommendations, for example, permitting users to initiate purchase of the comparable products simply by clicking on the item in the list.

In one embodiment, the user interface 840 may include a list 841 of recalled products arranged by brand. For example, the user may select a brand or elect to receive notifications from a particular brand regarding products produced by the brand that have been recalled. In one embodiment, the list 841 may include information including the date of the recall, product name, product description, and reason for recall.

FIG. 8D is a diagram of an extended user interface utilized in the processes of FIG. 4, according to one embodiment. In one embodiment, user interface 850 may determine locations of vendors selling the recalled product. For example, user interface 850 may include a map 851 marked with locations of such vendors. As previously discussed, the system 100 may render map 851 based on user location. In one embodiment, the user interface 850 may further include navigational screens 853 guiding users to the locations.

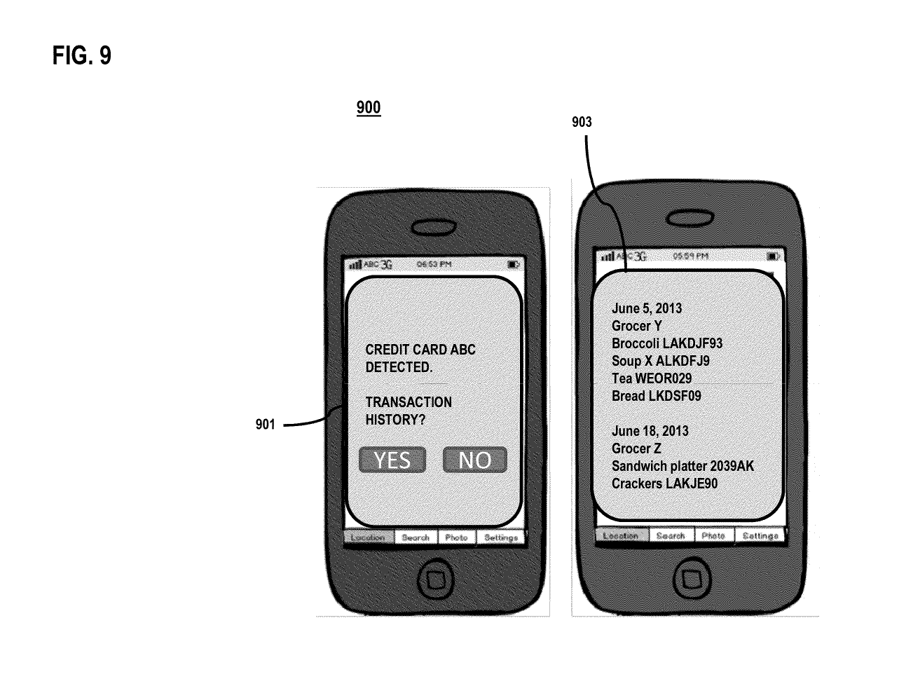

FIG. 9 is a diagram of a user interface utilized in the processes of FIG. 4, according to one embodiment. In one embodiment, user interface 900 may include a display of a user's transaction history. For example, prompt 901 may include an approval message showing that a transaction history is available. For example, a device may detect that a user wants to access a transaction history of credit card “ABC,” for example, by the user initiating an application or scanning the credit card using the device. Then, the device may present prompt 901 to initiate retrieval of the transaction history for a user's credit card ABC. In one embodiment, list 903 may include information including location of a transaction and transaction date. List 903 may further show the transaction history including information, for example, products and product identification codes.

The processes described herein for providing for providing a metadata management framework may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

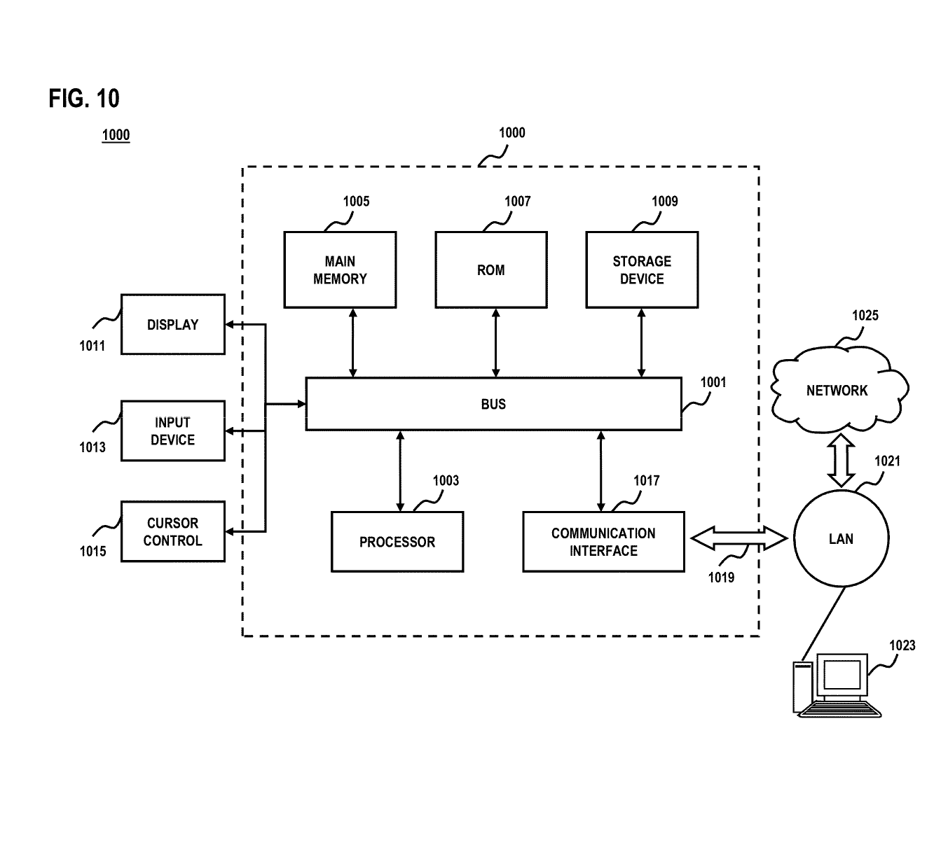

FIG. 10 is a diagram of a computer system that can be used to implement various embodiments. The computer system 1000 includes a bus 1001 or other communication mechanism for communicating information and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 11 illustrates a chip set 1100 upon which an embodiment of the invention may be implemented. Chip set 1100 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of FIGS. 4-7.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
parsing a transaction history to determine a product acquired by a user;
determining recall information associated with the product; and
presenting a notification to the user regarding the recall information.

2. A method of claim 1, wherein the notification to the user includes a date of an acquisition of the product, a date of the recall information, or a combination thereof.

3. A method of claim 1, further comprising:
initiating a refund request for the product based on the recall information, the notification, the transaction history, or a combination thereof.

4. A method of claim 1, further comprising:
monitoring one or more transactions conducted by the user on at least one device to generate the transaction history.

5. A method of claim 1, further comprising:
determining the transaction history from an electronic payment provider, an image recognition of a receipt for the product, or a combination thereof.

6. A method of claim 1, further comprising:
determining another product at least substantially comparable to the product; and
presenting the another product to the user as a recommendation.

7. A method of claim 1, further comprising:
identifying one or more vendor locations associated with the product; and
presenting the one or more vendor locations to the user.

8. A method of claim 1, further comprising:
determining a brand associated with the product; and
presenting other recall information associated with one or more other products of the brand.

9. A method of claim 1, further comprising:
determining the recall information from a querying of a product recall database, an image recognition of a physical product recall notice, or a combination thereof.

10. An apparatus comprising:
at least one processor; and
at least one memory including computer program code for one or more programs,
the at least one memory and the computer program code configured to, with the at least one processor, cause the apparatus to perform at least the following,
parse a transaction history to determine a product acquired by a user;
determine recall information associated with the product; and
present a notification to the user regarding the recall information.

11. An apparatus according to claim 10, wherein the notification to the user includes a date of an acquisition of the product, a date of the recall information, or a combination thereof.

12. An apparatus according to claim 10, wherein the apparatus is further caused to:
initiate a refund request for the product based on the recall information, the notification, the transaction history, or a combination thereof.

13. An apparatus according to claim 10, wherein the apparatus is further caused to:
monitor one or more transactions conducted by the user on at least one device to generate the transaction history.

14. An apparatus according to claim 10, wherein the apparatus is further caused to:
determine the transaction history from an electronic payment provider, an image recognition of a receipt for the product, or a combination thereof.

15. An apparatus according to claim 10, wherein the apparatus is further caused to:
determine another product at least substantially comparable to the product; and
present the another product to the user as a recommendation.

16. An apparatus according to claim 10, wherein the apparatus is further caused to:
identify one or more vendor locations associated with the product; and
present the one or more vendor locations to the user.

17. An apparatus according to claim 10, wherein the apparatus is further caused to:
determine a brand associated with the product; and
present other recall information associated with one or more other products of the brand.

18. An apparatus according to claim 10, wherein the apparatus is further caused to:
determine the recall information from a querying of a product recall database, an image recognition of a physical product recall notice, or a combination thereof.

19. A system comprising:
a platform configured to parse a transaction history to determine a product acquired by a user;
wherein the platform is further configured to determine recall information associated with the product, and to present a notification to the user regarding the recall information.

20. A system according to claim 19, wherein the notification to the user includes a date of an acquisition of the product, a date of the recall information, or a combination thereof.
